(19) United States
(12) Patent Application Publication
(10) Pub. No.: US 2018/0094218 A1
(43) Pub. Date: Apr. 5, 2018

(54) METHOD OF USING A CLEANING PRODUCT FOR USE IN A DEVICE COMPRISING A GRINDER

(71) Applicant: Urnex Brands, LLC, Elmsford, NY (US)

(72) Inventor: Kofi Amoako, New Windsor, NY (US)

(21) Appl. No.: 15/819,051

(22) Filed: Nov. 21, 2017

Related U.S. Application Data
(62) Division of application No. 15/245,609, filed on Aug. 24, 2016.

(51) Int. Cl. C11D 7/44; A47J 31/60; B08B 7/00; C11D 7/26; C11D 7/32; B08B 9/08

(52) U.S. Cl. CPC C11D 7/44; A47J 31/60; B08B 7/00; B08B 9/08; C11D 7/261; C11D 7/3281

(57) ABSTRACT

A cleaning material for use in a device comprising a grinder comprises at least one organic material processed to retain hygroscopic properties while having reduced components leading to gelling or thickening of the at least one organic material, as well as a binder and a humectant. In an embodiment, the cleaning material comprises about 80-89 wt % of the at least one organic material, about 10-15 wt % of the binder and about 1-5 wt % of the humectant. In another embodiment, the at least one organic material may comprise malted wheat grain that is heated for 30-40 minutes at approximately 150° F., followed by further heating in successive 30 minute intervals in which temperature is increased in each interval by 50° F. until 400° F. is reached, followed by further heating for approximately 2.5 hours at 400° F., followed by introduction of water into the rotating drum and forced air cooling.

### CROSS-REFERENCE TO RELATED APPLICATION

The instant application is a divisional of a co-pending U.S. patent application entitled CLEANING PRODUCT FOR USE IN A DEVICE COMPRISING A GRINDER AND METHODS FOR PRODUCING AND USING SAME having application Ser. No. 15/245,609, and filed on Aug. 24, 2016, the teachings of which are incorporated herein by this reference.

### FIELD

The instant disclosure relates generally to a cleaning product and, in particular, to a cleaning product for use in a device comprising a grinder as well as methods for producing and using same.

### BACKGROUND

Fully automatic coffee machines (sometimes also referred to as superautomatic or bean-to-cup coffee machines) are a relatively recent and welcome development in the realm of brewed beverages. As known in the art, such fully automatic machines typically comprise a grinder to grind coffee beans, a water tank, a heating device for heating the water and a brewing unit that receives the ground coffee beans and the water heated by the heating device to provide the desired brewed beverage. As further known in the art, the grinder is one of the essential tools in coffee brewing and it determines the quality of the brewed cup. Over time, coffee grinders can get soiled due to buildup of oils and dust, leading to off-taste and poor brews. Such soiling, if not remedied, can lead to broken parts, decreased performance, or even grinder motor burn-out if the buildup is severe. Even worse, if the residual oils are not removed, they will become rancid over time affecting performance and the taste of the brewed beverage.

Typically to clean the grinder in a fully automatic machine, one needs to disassemble the unit by removing a hopper (for storing coffee beans to be introduced to the grinder), the upper grinder casing if applicable, and any other components preventing ready access the grinder burrs. Thereafter, one must thoroughly wipe down the grinder burrs or work at them with a soft brush to remove any residue. Once cleaned, the grinder burrs and previously-removed components must be reassembled in order to resume brewing operations.

Other cleaning techniques for coffee grinders, not forming a part of a fully automatic machine, are known in the art. For example, in U.S. Pat. Nos. 8,216,385 and 8,382,907 (the “'385 and '907 patents”, the teachings of which are incorporated herein by this reference), assigned to the same assignee as the instant application, a cleaning material based on organic materials is disclosed that may be introduced into a grinder. By performing normal grinding operations on the disclosed cleaning material, the friction created by the cleaning material with grinder burrs removes the residue buildup, thereby avoiding the need to disassemble the grinder unit and manually clean the grinder burrs. Once ground in this manner, the disclosed cleaning material (along with any removed residue) is discharged from the grinder unit in the normal fashion. Any remaining traces of the cleaning material can be removed from the grinder unit by running a “purge” cycle in which the usual materials to be ground (i.e., coffee beans) are once again ground after the cleaning material.

While the cleaning material disclosed in the '385 and '907 patents has been successfully used in grinder-only devices, it is generally not a workable solution for fully automatic machines due to the presence of water in those machines. That is, if the cleaning material disclosed in the '385 and '907 patents is used in a fully automatic machine by processing the cleaning material through the grinder and subsequent brewing unit, the introduction of water into contact with the cleaning material leads to gelling of the cleaning material and clogging of the brewing unit and other downstream components.

Thus, it would be advantageous to provide a grinder cleaning material for use in fully automatic machines that does not suffer from the same limitations as prior art cleaning materials.

### SUMMARY

The instant disclosure describes a cleaning material for use in a device comprising a grinder that overcomes the above-noted limitations. In particular, a composition of matter that may be used as such a cleaning material comprises at least one organic material processed to retain hygroscopic properties while having reduced components leading to gelling or thickening of the at least one organic material in the presence of water, as well as a binder and a humectant. In an embodiment, the binder is a water-soluble polymer such as polyvinylpyrrolidone or other known binders whereas the humectant may comprise glycerin or other known humectants. In an embodiment, the at least one organic material may comprise corn cobs, walnut shells, pecan shells, nuts, rice, dried corn kernels, corn meal, corn husks, barley, wheat, bulgur, legumes, oatmeal, quick oats, grits and rice hulls, or combinations thereof.

In one embodiment, the cleaning product may comprise about 80-89 wt % of the at least one organic material processed as noted above (and described in further detail below), about 10-15 wt % of the binder and about 1-5 wt % of the humectant. Where the at least one organic material comprises malted wheat grain, the cleaning product may comprise about 87 wt % of the malted wheat grain.

In one embodiment, the at least one organic material may comprise malted wheat grain that is processed, prior to combination with the binder and humectant, by heating the malted wheat grain in a rotating drum for 30-40 minutes at approximately 150° F., followed by further heating of the malted wheat grain in successive 30 minute intervals in which temperature is increased in each interval by 50° F. until 400° F. is reached, followed by further heating of the malted wheat grain for approximately 2.5 hours at 400° F., followed by introduction of water into the rotating drum and forced air cooling. Related methods of producing and using the presently-described cleaning product are also described.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is a flowchart of a method for producing a cleaning product in accordance with the instant disclosure; and

FIG. 2 is a flowchart of a particular embodiment for processing an organic material in accordance with the instant disclosure.

### DETAILED DESCRIPTION OF THE PRESENT EMBODIMENTS

As used throughout this disclosure, the abbreviation “wt %” refers to percentage by weight meaning the ratio (expressed as a percentage) of the weight of one substance to the weight of the total mixture of which the substance is a constituent. Additionally, as used herein, words of approximation (e.g., “about,” “approximately,” “around,” “substantially,” etc. or synonyms thereof) describe deviations from the described conditions that nevertheless lead to the same result, as understood by those having ordinary skill in the art or as set forth in the examples below. Further still, various parameter values provided herein, such as specific temperatures, time durations and wt % are understood to mean within usual manufacturing tolerances.

In an embodiment, a cleaning product in accordance with the instant disclosure comprises at least one organic material processed to retain hygroscopic properties while having reduced components leading to gelling or thickening of the at least one organic material in the presence of water, a binder and a humectant. Generally, the at least one organic material employed for this purpose is safe for human consumption and additionally exhibit a desired degree of hardness and abrasiveness sufficient to remove residues typically found on grinder burrs. By way of non-limiting example, the at least one organic material may comprise corn cobs, walnut shells, pecan shells, nuts, rice, dried corn kernels, corn meal, corn husks, barley, wheat, bulgur, legumes, oatmeal, quick oats, grits and rice hulls, or combinations thereof. In a particular example described in further detail below, the at least one organic material may comprise malted wheat grain, and a specific method for processing malted wheat grain to retain it hygroscopic properties while having reduced components leading to gelling or thickening is described below with reference to FIG. 2.

The binder component of the cleaning product may comprise any material safe for human consumption and suitable for maintaining the constituent materials of the cleaning product is a desired shape or form. In an embodiment, the binder may comprise a water-soluble polymer, such as polyvinylpyrrolidone. Other suitable non-limiting examples of water-soluble polymers may include polyethylene glycol (PEG), water soluble pharmaceutical binders and polyvinyl alcohols. Likewise, the humectant component of the cleaning product may comprise any hygroscopic material safe for human consumption and that helps prevent loss of moisture in the cleaning product and minimize dust during use of the cleaning product. Suitable, non-limiting examples of humectants for this purpose include glycerin, polyethylene glycol and sorbitol solution.

In an embodiment, the cleaning product in accordance with the instant disclosure may comprise about 80-89 wt % of the at least one organic material processed as noted above (and described in further detail below), about 10-15 wt % of the binder and about 1-5 wt % of the humectant. In the case where the at least one organic material comprises malted wheat grain, the cleaning product may comprise about 87 wt % of the malted wheat grain.

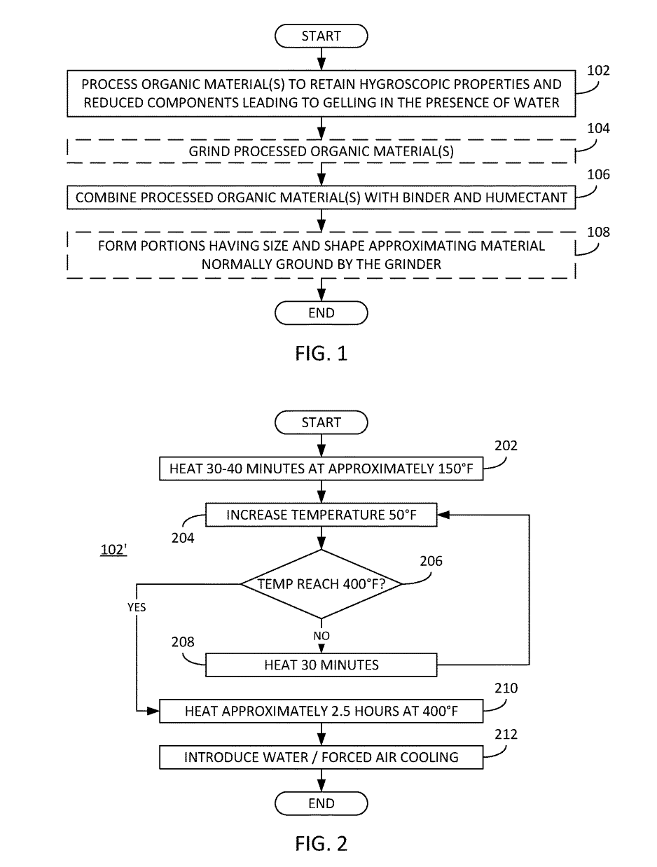

Referring now to FIG. 1, a method for producing a cleaning product in accordance with the instant disclosure is further described. Beginning at block 102, the at least one organic material is processed to retain hygroscopic properties of the at least one organic material while also reducing any components of the at least one organic material that typically leads to gelling or thickening in the presence of water. For example, certain proteins/enzymes contribute to the thickening or gelling properties of various organic materials. By breaking down such enzymes to reducing sugars and amino acids, the thickening or gelling properties of the organic material may be reduced. In an embodiment, a process for breaking down such enzymes is based on the so-called Maillard reaction resulting from heating of the organic material. A specific implementation of such a process 102′ with particular applicability to malted wheat grain is further described with reference to FIG. 2. While other processes for breaking down such enzymes, particularly based on chemical processing thereof, may be suitable for use in conjunction with the teachings of the instant disclosure, they are generally not preferred.

In particular, the process of FIG. 2 begins at block 202 where a desired quantity of malted wheat grain is placed into a rotating roasting drum of the type well-known in the art and heated for 30-40 minutes at approximately 150° F. At the conclusion of that initial time interval, the process proceeds to blocks 204-208 where the roasting temperature is slowly increased over multiple time intervals until a desired temperature is reached. In particular, at block 204, the heating temperature is increased by 50° F. and, at block 206, it is determined whether the increased heating temperature has reached 400° F. If not, processing continues at block 208 where the increased heating temperature is used to heat the malted wheat grain for 30 minutes. At the conclusion of the heating of block 208, processing continues at blocks 204 and 208 in which the heating temperature is increased 50° F. and a determination made whether the heating temperature has reached 400° F. The processing of blocks 204-208 is repeated until such time that the condition of block 206 is met, i.e., the heating temperature reaches 400° F. Thereafter, processing continues at block 210 where the malted wheat grains are heated for approximately 2.5 hours at the 400° F. heating temperature. At the conclusion of block 210, water is introduced into the roasting drum and force air cooling is applied to the now-processed malted wheat grain.

It is noted that the specific process 102′ illustrated in and described with reference to FIG. 2 is particularly applicable to malted wheat grain. As those having ordinary skill in the art will appreciate, other types of organic materials or combinations thereof may require a similar Maillard reaction-based process tailored to the specific material(s) being processed. For example, the above-described process may be altered to take into consideration the moisture and protein content (comprising nitrogen-rich amino acids that lead to the undesired thickening or gelling) of the organic material to be processed. In the case where multiple organic materials are employed, such material-specific processes may be performed separately on the constituent materials with the resulting processed organic materials thereafter being combined.

Referring once again to FIG. 1, regardless of the particular method employed to process the at least one organic material to retain its hygroscopic properties and reduced any thickening or gelling components, processing may optionally continue at block 104 where they are ground to a desired particle size. For example, in an embodiment, grinding is performed so that the resulting particle sizes have a bell curve distribution (i.e., non-uniform) within a range of about 0.85 mm to about 0.150 mm. The non-uniform particle size of the processed organic material facilitates the formation of portions of the cleaning product into desired shapes and sizes.

Regardless whether the grinding of block 104 is performed, the method continues at block 106 where the processed organic material(s) are combined with a binder and humectant in accordance with the above described proportions. In an embodiment, a spray dry process is used for this purpose. In particular, the organic material (as processed above) is placed into conventional mixing equipment and sprayed with the humectant during mixing. During this step, 1% isopropyl alcohol (IPA) is added to the mixture to facilitate drying of the cleaning product through evaporation of the IPA. Thereafter, the binder is added for further mixing until a substantially homogenous blend is achieved.

As further shown in FIG. 1, processing may optionally continue at block 108 where the cleaning product resulting from the combining of block 106 may be formed into portions having a shape and size approximating a shape and size of a material normally ground by the grinder. For example, the cleaning product can be formed into tablets having approximately the same size and shape of coffee beans. Techniques for forming such portions are well known in the art and are described, for example, in the '385 and '907 patents referenced above.

A cleaning product comprising a composition of matter formed as described herein finds particular applicability for use in cleaning grinders within fully automatic beverage machines. In particular, a sufficient or desired quantity of the cleaning product may be placed into the device comprising the grinder burrs to be cleaned, after which the cleaning material is subjected to grinding in accordance with normal operation of the device. Because the cleaning product is designed to effectively replace the materials normally ground by the device, introduction of the cleaning material is as simple as placing the cleaning material into a hopper or feeder typically provided in fully automatic machines, without the need for disassembly of any kind. For example, in the case of a fully automatic coffee or espresso machine, the cleaning material may be placed in the input hopper resulting in the cleaning material being subjected to the normal grinding process, thereby removing any residue from the grinder burrs. Thereafter, the resulting ground cleaning material is subjected to a normal brewing cycle and discharge of the spent grounds. Given the reduced gelling or thickening properties of the cleaning material, exposure of the cleaning material to water during the brewing cycle does not result in clogging of the brewing unit or any other downstream components.

While particular preferred embodiments have been shown and described, those skilled in the art will appreciate that changes and modifications may be made without departing from the instant teachings. It is therefore contemplated that any and all modifications, variations or equivalents of the above-described teachings fall within the scope of the basic underlying principles disclosed above and claimed herein.

What is claimed is:

1. A method of cleaning a device comprising a grinder, the method comprising:
placing a composition of matter in the device, the composition of matter comprising at least one organic material processed to retain hygroscopic properties while having reduced components leading to gelling or thickening of the at least one organic material in the presence of water, a binder and a humectant; and
grinding the composition of matter using the grinder.

2. The method of claim 1, wherein placing the composition of matter in the device further comprises placing the composition of matter in an intake hopper of the device without disassembly of the device.

3. A method of cleaning a device comprising a grinder, the method comprising:
placing a composition of matter in the device, the composition of matter comprising at least one organic material processed to retain hygroscopic properties while having reduced components leading to gelling or thickening of the at least one organic material in the presence of water, a binder and a humectant, wherein the at least one organic material comprises about 87 wt % of malted wheat grain and wherein the malted wheat grain is processed by heating the malted wheat grain in a rotating drum for 30-40 minutes at approximately 150° F., followed by further heating of the malted wheat grain in successive 30 minute intervals in which temperature is increased in each interval by 50° F. until 400° F. is reached, followed by further heating of the malted wheat grain for approximately 2.5 hours at 400° F., followed by introduction of water into the rotating drum and forced air cooling; and
grinding the composition of matter using the grinder.

4. The method of claim 3, wherein placing the composition of matter in the device further comprises placing the composition of matter in an intake hopper of the device without disassembly of the device.
